(19) United States
(12) Patent Application Publication
(10) Pub. No.: US 2002/0187082 A1
(43) Pub. Date: Dec. 12, 2002

(54) Photocatalyst coated magnetic composite particle

(76) Inventors: Chang-Yu Wu, Gainesville, FL (US); Yogi Goswami, Gainesville, FL (US); Charles Garretson, Alachua, FL (US); Jean M. Andino, Gainesville, FL (US); David W. Mazyck, Gainesville, FL (US)

Correspondence Address: Gregory A. Nelson, Esq., Akerman, Senterfitt & Eidson, P.A., 222 Lakeview Avenue, Suite 400, P.O. Box 3188, West Palm Beach, FL, 33402-3188, US

(21) Appl. No.: 10/162,845

(22) Filed: Jun. 5, 2002

Related U.S. Application Data
(60) Provisional application No. 60/296,524, filed on Jun. 6, 2001.

(51) Int. Cl. B01J 8/18; B01F 3/00

(52) U.S. Cl. 422/139; 422/224

(57) ABSTRACT

A magnetic photocatalyst composite particle includes a magnetic composition and at least one photocatalyst particle secured to the magnetic composition. The magnetic photocatalyst composite particles can be nano-sized. The magnetic photocatalyst composite particles permit high levels of photocatalytic chemical activity to be combined with controllable particle movement and allow the formation of improved reactors for the treatment of water and air.

### CROSS-REFERENCE TO RELATED APPLICATIONS

This application claims the benefit of U.S. Provisional Application No. 60/296,524 entitled “PHOTOCATALYST COATED MAGNETIC COMPOSITE PARTICLE” filed Jun. 6, 2001, the entirety of which is incorporated herein by reference.

### STATEMENT REGARDING FEDERALLY SPONSORED RESEARCH OR DEVELOPMENT

This invention was made with U.S. Government support through Cooperative Agreement No. NCC 9-110 awarded by the National Aeronautics and Space Administration (NASA). The U.S. Government may have certain rights in the invention.

### BACKGROUND OF THE INVENTION

Since the industrial revolution, the release of harmful emissions and discharge into the environment has adversely impacted the environment and human health. For example, emissions from a variety of stationary and mobile sources generate a variety of pollutants, such as nitrogen oxides (NOₓ), sulfur dioxide (SO₂) and certain volatile organic compounds (VOCs). Such pollutants and their subsequent derivatives are known to be responsible for acid rain, visibility degradation, property damage and various health problems.

While the rate of development and waste production are not likely to diminish going forward, efforts to control and dispose of wastes appropriately are increasing. Two of the most important considerations regarding waste control is the protection of the earth's potable water supply and air quality.

Although there are several conventional pollution control techniques available, the development of new or improved technology is important in overcoming the limitations of current technologies. For example, photocatalyst based technology has been shown to degrade certain pollutants with minimal energy input. As a result, the use of photocatalysts in pollution control systems is generally regarded as a promising technique. However, photocatalyst based technology has generally provided relatively slow overall reaction kinetics, with the exception of a slurry system that is used for water purification.

Titania (TiO₂) is currently the photocatalyst of choice for most applications, being the most efficient known photocatalyst. Irradiation of a semiconductor, such as TiO₂, with light having an energy equal to or greater than the semiconductor material's band gap energy results in the creation of electrons in the semiconductor's conduction band and holes in its valence band. The injection of these electrons and holes into a fluid region surrounding the semiconductor particles causes electrochemical modification of substances within this region. This technology has been used in photocatalytic processes such as the photo-Kolbe reaction in which acetic acid is decomposed to methane and carbon dioxide and the photosynthesis of amino acids from methane-ammonia-water mixtures (References).

Catalytic action results when a catalytic agent reduces the activation energy required to drive a chemical reaction to completion. In ordinary heterogeneous catalysis, the activation energy, Ea, is provided by heat and the catalyst reduces the amount of heat required. Hence, the catalyst permits driving the chemical reaction at a faster rate at a given temperature or alternatively, lowers the temperature at which a given reaction rate occurs. In contrast, in photocatalysis, the Ea is provided by the photon energy of the incident light.

Photocatalysis is distinguishable from ordinary heterogeneous catalysis in that it employs visible and ultraviolet (UV) radiation to facilitate chemical reactions rather than thermal energy (i.e., heat). Light has a very high free energy content and can be converted into high levels of electron excitation energy when absorbed by semiconductors. Thus, optically excited semiconductors can drive chemical reactions, even at room temperature, by providing Ea in the form of high energy electrons and holes. Although the infrared (IR) part of the spectrum is also considered electromagnetic radiation, its absorption by matter normally results in only heating of the catalyst and/or chemical reactants. Thus, in ordinary catalysis, thermal energy derived from IR irradiation, direct heating or even microwave irradiation, manifests itself as an elevated temperature (increased energy of translational, rotational, and vibrational modes) of the chemical reactants and the catalyst for providing the activation energy for the chemical reaction. The ordinary catalyst is generally optically passive, and only provides an adsorbing surface for diminishing the activation energy of reactants.

As a result, the role played by IR, visible, and UV light in ordinary catalysis compared to photocatalysis is fundamentally different. In contrast to ordinary catalysis, in heterogeneous photocatalysis, the catalyst's optical properties become important. Photocatalysts are generally semiconductor materials. By absorption of appropriate light having energies which can provide the semiconductor band-gap energy, electron and hole carrier pairs are produced within the photocatalyst particles. These charged carriers can then perform redox reactions with the adjacent chemical species. Ordinary catalytic properties, as described above, may also be a feature of the photocatalytic process. Additionally, ordinary thermal processes may also play a secondary role in reaction kinetics (e.g., absorption of any wavelength light could result in some system heating). However, the distinguishing feature of photocatalytic reactions is that the activation energy of reaction results primarily from optical processes and the subsequent generation and transfer of electrons and holes (i.e., redox chemistry), rather than just heating.

Certain solid-phase semiconductors, such as TiO₂, ZnO and Fe₂O₃, have been shown to be excitable by near-UV light, available from sunlight or from a man-made generator. In the presence of water and oxygen, the redox reaction produces hydroxyl radicals. The hydroxyl radicals that are generated can oxidize most organic pollutants, as they do in UV/hydrogen peroxide and UV/ozone treatment systems. Given sufficient exposure time, organic wastes will be oxidized into CO₂ and water, and in the case of halogenated compounds, weak mineral acids. This reaction rate depends on the organic matrix to be treated, the reactor design, and the photon flux. Relevant reactor design parameters include photocatalyst loading, and contact between pollutants and the photocatalyst.

Regarding titania, under UV light exposure, OH radicals are generated on the titania surfaces which can subsequently react with organic (and some inorganic) compounds in the system. Many studies using titania to treat pollutants have been conducted (e.g. Alberici, R. M. Jardim, W. F., “Photocatalytic Destruction of VOCs in the Gas-Phase Using Titanium Dioxide”, Applied Catalysis B: Environmental, 14 (1-2), 1997, 55-68; Crittenden, J. C., Liu, J., Hand, D. W. and Perram, D. L., “Photocatalytic Oxidation of Chlorinated Hydrocarbons in Water”, Wat. Res., 31(3), 1997, 429-438; Eggins, B. R., Palmer, F. L. and Byrne, J. A., “Photocatalytic Treatment of Humic Substances in Drinking Water”, Wat. Res., 31(5), 1997, 1223-1226; Goswami, D. Y., Trivedi, D. M. and Block, S. S., “Photocatalytic Disinfection of Indoor Air”, J. Solar Energy Eng., 119, 1997, 92-96; Wu, C. Y., Lee, T. G., Arar, E., Tyree, G. and Biswas, P., “Capture of Mercury in Combustion Environments by In-Situ Generated Titania Particles with UV Radiation”, Env. Eng. Sci., 15(2), 1998, 137-148; Jacoby, W. A., Maness, P. C., Wolfrum, E. J., Blake, D. M. and Fennell, J. A., “Mineralization of Bacterial Cell Mass on a Photocatalytic Surface in Air”, Environ. Sci. Technol., 32(17), 1999, 2650-2653). Enhanced removal efficiencies have also been reported by modifying the titania material so that radicals are generated more readily. For example, titania doped with Ag or Pt has been shown to perform better than undoped titania (Avila, P. Bahamonde, A. Blanco, J. Sanchez, B. Cardona, A. I. and Romero, M., “Gas-phase photo-Assisted Mineralization of Volatile Organic Compounds by Monolithic Titania Catalysts”, Applied Catalysis B: Environmental, 17(1-2), 1998, 75-88). An external electrical field can also enhance titania's removal efficiency due to more efficient electron transfer (Butterfield, I. M., Christensen, P. A., Curtis, T. P. and Gunlazuardi, J., “Water Disinfection Using an Immobilized Titanium Dioxide Film in a Photochemical Reactor with Electric Field Enhancement”, Wat. Res., 31(3), 1997, 675-677).

In treating air pollutants, most studies have used nano-sized titania particles because they are much more effective than titania particles in the micron range or larger. Nano-sized titania particles have either been deposited on substrate particles for packed beds (e.g. Kobayakawa, K., Sato, C., Sato, Y., Fujishima, A., “Continuous-flow Photoreactor Packed with Titanium Dioxide Immobilized on Large Silica Gel Beads to Decompose Oxalic Acid in Excess Water”, J. Photochemistry & Photobiology A: Chemistry, 118, 1998, 65-69; Yuan, C. S., Hsu, B. C., Wu, J. F. and Hung, C. H., “Reaction Products of Gas-Phase Photocatalytic Degradation of Perchloroethylene over Titanium Dioxide (UV/Ti02)” 92^{nd} Annual Meeting of the Air and Waste Management Association, Jun. 20-24, 1999, St. Louis, Mo., Paper No. 99-616), or on reactor tube walls as a thin film (Alberici, R. M. Jardim, W. F., “Photocatalytic Destruction of VOCs in the Gas-Phase Using Titanium Dioxide”, Applied Catalysis B: Environmental, 14(1-2), 1997, 55-68). A packed bed is not an optimal system for photocatalysis because the effective photocatalyst fraction is only the outer layer of the bed that is exposed to the light.

A titania thin film is more commonly applied because light can be effectively transmitted to most of the titania particles. However, the immobilization of titania particles on tube walls limits the mass transfer rate and as a result, the overall reaction kinetics. This limitation can be overcome by using a system that promotes contact between the titania particles, the light and the pollutants, such as a “photocatalytic fluidized bed” system. Unlike in a packed bed, particles in such a fluidization system are frequently exposed to the UV light. Meanwhile, the rigorous turbulence in such a system greatly improves the mixing between the reactants (e.g., pollutants) and the radicals generated therein.

However, several obstacles remain to be solved before a photocatalytic fluidized bed employing nano-sized titania particles can be effectively used. First, mechanical fluidization requires large particle sizes (e.g., at least 100 μm) to permit gravitational settling. Meanwhile, preserving the premium photocatalytic ability of the nano-sized photocatalyst particles is critical to the process. To fulfill both criteria, large core particles that have nano-sized photocatalytic particles on their surface can be used. Preferably, the binding force between the nano-sized photocatalyst particle surface and the particle core should be strong enough to sustain the intensive friction that typically occurs during operation of a fluidized bed.

Nano-sized particles deposited on the surface of substrate particles have been prepared in solution (Kobayakawa, K., Sato, C., Sato, U., Fujishima, A., “Continuous-flow Photoreactor Packed with Titanium Dioxide Immobilized on Large Silica Gel Beads to Decompose Oxalic Acid in Excess Water”, J. Photochemistry & Photobiology A: Chemistry, 118, 1998, 65-69; Yuan, C. S., Hsu, B. C., Wu, J. F. and Hung, C. H., “Reaction Products of Gas-Phase Photocatalytic Degradation of Perchlorethylene over Titanium Dioxide (UV/TiO₂)” Annual Meeting of the Air and Waste Management Association, Jun. 20-24, 1999, St. Louis, Mo., Paper No. 99-616). However, the nano-sized particles formed are not tightly bound to the substrate, due to generally weak binding forces. Accordingly, to implement viable substrates coated with nano-sized particles for use in a fluidized bed, the composite particles formed should possess sufficient binding forces between the substrate core and the nano-sized particles to withstand frictional forces exerted during operation of the fluidized bed.

Thus, improved photocatalyst particles are needed to provide photocatalytic fluidized beds having improved efficiency. The improved particles should provide photocatalytic capability for treating reactants, such as pollutants, and have a property that permits their control and selective separation from a mixture.

### SUMMARY

A magnetic photocatalyst composite particle includes a magnetic composition, such as a magnetic core particle, and at least one photocatalyst particle secured to the magnetic composition. The photocatalyst particles are preferably nano-sized. The nano-sized photocatalyst particles can be substantially uniformly distributed on a surface of the magnetic composition. The magnetic photocatalyst composite particles can include a protective layer disposed on the magnetic composition for preventing chemical attack of the magnetic composition.

The nano-sized photocatalytic particles can be TiO₂, ZnO or Fe₃O₄. The magnetic composition can be any magnetic composition, such as Fe₃O₄, Fe₂O₃, BaO(Fe₂O₃)₆, SrO(Fe₂O₃)₆ or AlNiCo.

In an alternative embodiment of the invention, a magnetic photocatalyst composite particle includes a substrate core and at least one nano-sized photocatalyst particle and at least one nano-sized magnetic particle, the nano-sized particles disposed on the substrate core. The nano-sized photocatalytic particles can be TiO₂, ZnO or Fe₂O₃. The substrate core can be Fe₃O₄, Fe₂O₃, BaO(Fe₂O₃)₆, SrO(Fe₂O₃)₆ or AlNiCo.

A chemical reactor includes a photocatalytic fluidized bed comprising a plurality of magnetic photocatalyst composite particles, the magnetic photocatalyst composite particles including a magnetic composition and at least one photocatalyst particle secured to the magnetic composition. The reactor includes structure for creating turbulence for mixing. The photocatalyst particles can be nano-sized.

The magnetic photocatalytic composite particles can be a first particle type having a magnetic composition and at least one nano-sized photocatalyst particle secured to the magnetic composition or second particle type having a substrate core and at least one nano-sized photocatalyst particle and at least one nano-sized magnetic particle secured to the substrate core.

A photocatalyst fluidized bed includes a plurality of magnetic photocatalyst composite particles. The magnetic photocatalyst composite particles include a magnetic composition and at least one photocatalyst particle secured to the magnetic composition and structure for creating turbulence for mixing. The photocatalyst particles can be nano-sized. The structure for creating turbulence can include a magnetic field source, such as a collar coil.

A method for performing photocatalysis includes the steps of providing magnetic photocatalyst composite particles in a fluidized bed, supplying light and a material to be purified intermixed with reactants to the fluidized bed, and applying a magnetic field to influence movement of the magnetic photocatalyst composite particles to increase mixing between the photocatalyst composite particles and the reactants.

The material to be purified can be any suitable fluid. For example, the material to be purified can be water or air. The reactants are susceptible to photocatalytic reaction and generally include one or more pollutants.

The magnetic photocatalyst composite particles can include nano-sized photocatalyst particles. The magnetic field can be a variable magnetic field. The method can include the step of varying the intensity of the light.

A method for controlling pollution includes the steps of providing a plurality of magnetic photocatalyst composite particles. The magnetic photocatalyst composite particles can be a first particle type having a magnetic composition, and at least one nano-sized photocatalyst particle secured to the magnetic composition and/or a second particle type having a substrate core and at least one nano-sized photocatalyst particle and at least one nano-sized magnetic particle secured to the substrate core. A magnetic field is applied to influence movement of the particles.

A process for forming magnetic photocatalyst composite particles includes the steps of providing a plurality of magnetic substrate particles, a plurality of nano-sized photocatalyst particles and a coating machine, the coating machine having a rotor and a vessel and a volume therebetween. The volume therebetween includes a region with a narrow rotor clearance relative to other volumes between the vessel and the rotor. The plurality of magnetic substrate particles and nano-sized photocatalyst particles are positioned in a volume between a vessel and a rotor. The rotor is rotated, wherein nano-sized photocatalyst particles coat the magnetic substrate particles.

Another process for forming magnetic photocatalyst composite particles includes the steps of providing a plurality of magnetic substrate particles, a plurality of photocatalyst particles and at least one oxidizing acid. The photocatalyst particles are dissolved in the acid to form a solution. The acid is removed, such as by heating the solution, wherein a plurality of photocatalyst particles are deposited on the surface of the magnetic substrate particles. The deposited photocatalyst particles can be nanosized.

### BRIEF DESCRIPTION OF THE DRAWINGS

A fuller understanding of the present invention and the features and benefits thereof will be accomplished upon review of the following detailed description together with the accompanying drawings, in which:

FIG. 1(a), (b) and (c) illustrate structures of various magnetic composite particles according to respective embodiments of the invention.

FIG. 2(a) illustrates a schematic view of a magnetically agitated photocatalyst reactor based system for the treatment of water, according to an embodiment of the invention.

FIG. 2(b) illustrates a schematic view of an annular reactor, according to an embodiment of the invention.

FIG. 2(c) illustrates a schematic view of a coil reactor, according to an embodiment of the invention.

FIG. 3(a) illustrates a schematic view of a magnetically agitated photocatalyst reactor-based system for the treatment of air, according to yet another embodiment of the invention.

FIG. 3(b) illustrates a schematic view of a central flow reactor, according to an embodiment of the invention.

FIG. 3(c) illustrates an enlarged view of the inlet entrance of the reactor shown in FIG. 3(b).

FIG. 3(d) illustrates a schematic view of a central lamp reactor, according to an embodiment of the invention.

FIG. 3(e) illustrates an enlarged schematic of reactor of the inlet entrance of the reactor shown in FIG. 3(d).

FIG. 4 depicts a mechanism used by the composite particles to remove VOCs.

FIG. 5 illustrates a method for forming magnetic composite particles, according to another embodiment of the invention.

FIGS. 6(a)-(e) illustrates SEM and EDX images of nano-sized TiO₂ coated magnetic substrate particles.

FIGS. 7(a)-(c) illustrates SEM and EDX images of nano-sized TiO₂ particles coated on polymethylmethacrylate (PMMA), the PMMA coating Fe₃O₄ core particles.

FIGS. 8(a)-(f) illustrates SEM, EDX and TEM images of PMMA particles coated with nano-sized TiO₂ and Fe₃O₄. FIGS. 9(a)-(f) illustrates SEM images of a magnetic substrate, PTFE, and a PTFE coated magnetic substrate.

FIGS. 10(a)-(c) illustrates SEM and surface elemental mapping by EDX of BaO(Fe₂O₃)₆ coated with a layer of PTFE and then nanosized TiO₂ particles.

FIG. 11 illustrates batch data showing the destruction of methylene blue dye as a function of time in a coil reactor using magnetic photocatalytic composite particles.

### DETAILED DESCRIPTION

Magnetic photocatalyst composite particles have been formed which permit high levels of photocatalytic chemical activity to be combined with controllable particle movement. Photocatalyst particles can be as small as nano-sized. Nano-sized is defined herein as a few nanometers (e.g. 2) to approximately 100 nanometers. Smaller, particularly nano-sized, photocatalyst particles are preferred because they are known to be more reactive than their larger counterparts.

The nano-sized photocatalyst particles can be combined with larger substrate particles to form magnetic photocatalyst composite particles. For example, nano-sized photocatalyst particles can be placed on the outer shell of substrates, including magnetic substrates, to catalyze chemical reactions.

The reactivity of the composite particles can be enhanced by control of their movement. By providing a composite particle which is magnetic, one or more magnetic fields can be used to control the movement of the composite particle.

Applied to a fluidized bed, the use of such composite particles in a photocatalytic fluidized bed enhances the contact between the photocatalyst, the light source and the reactant, improving the kinetics for treating reactants, such as pollutants. In addition, the ability to secure photocatalyst particles to magnetic compositions permits increased photocatalyst activity due to the ability to use smaller photocatalyst particles, being as small as nano-sized, compared to conventional fluidized bed systems which generally have minimum photocatalyst particle sizes of at least approximately 100 μm. The minimum photocatalyst particle size requirement in conventional fluidized bed systems is generally necessary to avoid photocatalyst particles from escaping out of the fluidized bed system during system operation.

The photocatalytic capability of the magnetic photocatalyst composite particles can be used to photocatalytically oxidize or reduce reactants, such as pollutants, depending on the environment. The photocatalytic capability of the magnetic photocatalyst composite particles can also be used to produce electricity or to synthesize useful materials. Meanwhile, the magnetic property of the composite particle allows for controlled movement, such as enhanced mixing with pollutants, separation and recovery from the system, fluidization in a micro-gravity environment or transport of the photocatalyst to a desired destination under one or more externally applied magnetic fields.

Magnetic photocatalyst composite particles can be formed from a magnetic substrate core and at least one photocatalyst particle secured to the magnetic substrate.

Nano-sized photocatalytic particles are preferably selected from TiO₂, ZnO and/or Fe₂O₃. Magnetic core particles can be any magnetic composition, such as Fe₃O₄, Fe₂O₃, BaO(Fe₂O₃)₆, SrO(Fe₂O₃)₆ or AlNiCo.

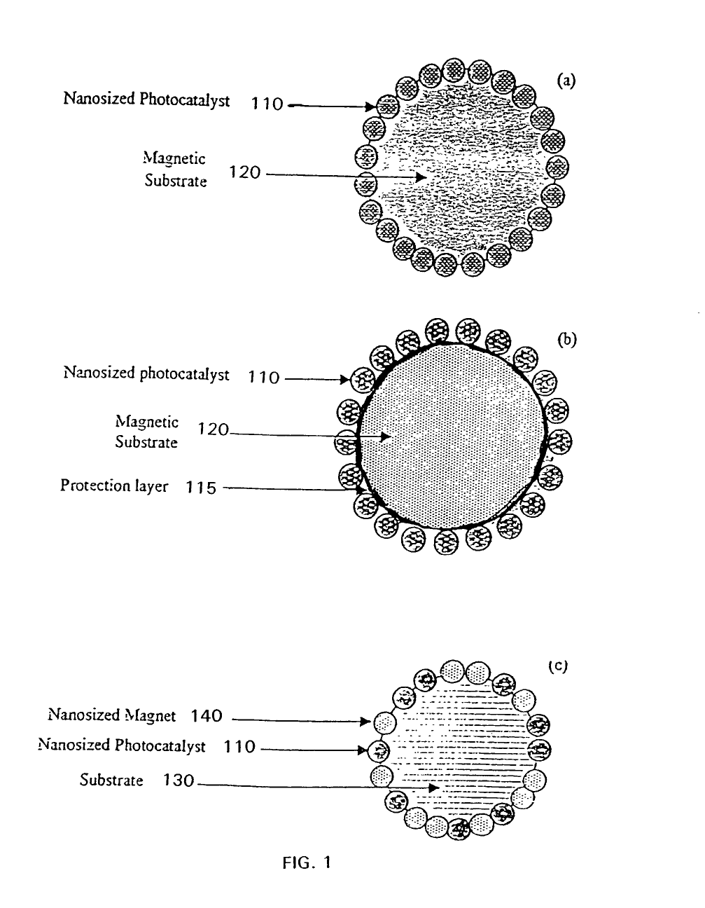

Referring to FIG. 1(a), the composite can be fabricated by coating a layer of nano-sized photocatalyst particles 110 onto the surface of magnetic core particles 120. Alternatively, as shown in FIG. 1(b), a protection layer 115, such as a polymer (e.g., tetraethylfluoroethylene), can be placed between the photocatalyst particles 110 and the magnetic substrate 120 to protect the magnetic material from harsh environments, such as acidic liquids or corrosive gases. Alternatively, as shown in FIG. 1(c), a substrate 130 can be co-coated with nano-sized magnetic particles 140 and nano-sized photocatalyst particles 110. The substrate 130 can be either magnetic or non-magnetic. Many other variations of magnetic photocatalyst composite particles, other than the structures shown in FIGS. 1(a), (b), and (c) will be apparent to those skilled in the art.

In most conventional photocatalytic devices for treating air pollutants, photocatalyst particles are either coated on beads for fixed bed reactors or coated on fiber or reactor walls. These devices experience either low mass transfer/kinetics, blocking of incident light or a pressure drop. Using particles producible from the invention, magnetic fluidization can be established by agitating the composite particles using an external magnetic field. The external magnetic field can be a time varying field, and can be formed from the superposition of more than one magnetic field source. Thus, the reaction efficiency can be increased because of enhanced mixing with reactants (e.g., pollutants) and more frequent exposure of the photocatalyst particles to light.

Thus, the resulting higher efficiency provided by the invention permits configuring systems having reduced overall sizes. In treating water pollutants, most proposed devices suggest the use of slurries containing nano-sized photocatalyst particles. However, the separation of nano-photocatalyst particles from water after treatment raises problems, sometimes requiring special filters.

Using the invention, separation can be achieved by applying magnetic forces to the magnetic composite particles. Moreover, movement by magnetic agitation can be used to improve mixing and exposure, analogous to those described for air pollution systems. Magnetic fields can also be used to create restraining forces to prevent composite particles from escaping from the fluidized bed system.

Conventional fluidized bed systems generally cannot use particles smaller than approximately 100 μm, otherwise system fluidization efficiency diminishes. In contrast, the invention permits use of substrate cores smaller than 100 μm and highly reactive nano-sized photocatalyst particles secured to the substrate cores.

Nano-sized photocatalysts are known to possess superior photocatalytic properties compared to the same materials with diameters in the micrometer or larger range (Technical Bulletin Pigments: Highly Dispersed Metallic Oxides Produced by the AEROSIL Process, No. 56, Inorganic Chemical Products Division, Degussa, 1995). In order to maximize the use of nano-sized titania particles, the photocatalyst can be coated onto a substrate, by using, for example, a dry coating technique. Dry particle coating is a relatively new technique. This process involves the use of a mechanical force to directly fix smaller (guest) particles on the surface of larger (host) particles. Thus, new materials with new functionality can be created. Since no liquid (solvent, binder, or water) is required, this process is an environmentally benign and cost-effective process. No post treatment of waste-water is required.

In a preferred embodiment of the invention, titania particles are preferably coated on substrate particles using a dry mechanical particle coating technique, such as mechanofusion. Mechanofusion directly coats fine particles on larger target particles. This can be done by exerting strong mechanical forces on the particles, such as the forces produced by an elliptical rotor rotating at high speed. For example, the mechanofusion process can be practiced using a Theta Composer, manufactured by Tokuju Inc., Kanagawa, Japan, as further explained in examples to follow.

Magnetic photocatalyst composite particles may also be formed by another method. A plurality of magnetic substrate particles, a plurality of photcatalyst particles and at least one oxidizing acid is provided. Strongly oxidizing acids are preferred, such as HF and HNO₃. The photocatalyst particles are dissolved in the acid to form a solution. The acid is then removed from the solution, preferable by vaporization though heating. For example, a temperature 105° C. may be used for certain acids. The vaporization rate increases as the temperature increases.

Following removal of the acid, a plurality of photocatalyst particles are deposited on the surface of the magnetic substrate particles. The deposited photocatalyst particles can be nanosized. The temperature, curing time, type of acid and photocatalyst concentration can be adjusted to control the size of the particles. Alternatively, the photocatalysts can be coated onto substrates by other methods, such as sol-gel.

Magnetically fluidized photocatalyst beds provide extremely fast photocatalytic oxidation resulting from enhanced mixing and exposure to UV light in fluidization and the use of generally superior titania photocatalyst particles. The fluidized bed is generally economical, since the raw materials and formation processes are inexpensive and generally reusable. The invention is easy to scale up or down, depending on the application.

Removal of reactant compounds flowing through the photocatalytic fluidized bed system is dependent on the generation rate of hydroxyl radicals. However, from an environmental perspective, it is important to consider not only the removal of the original pollutants, but the possible end products formed in the removal process. The atmospheric reactions of OH radicals with volatile organic compounds are quite complex in nature (Atkinson, R., Gas-phase tropospheric chemistry of organic compounds”, J. Phys. Chem. Ref. Data, Monograph 2, 1994, 1-216). However, in the presence of excess OH radicals, the oxidation of organic compounds leads almost exclusively to the formation of CO₂ and H₂O. These byproducts can then be trapped. Carbon dioxide can either be removed using current techniques employed or recycled for plant use. Water produced can be trapped, condensed, and recycled in a variety of ways.

A critical need in systems for recycling potable water is the destruction or removal of trace organic chemicals and microorganisms in recovered water and maintenance of microbiological quality in stored water. Photocatalytic fluidized beds (PFBs) can be used for chemical and microbe destruction to produce potable water.

An enhanced PFB according to the invention includes a fluidized bed of nano-sized TiO₂ particles which are secured to magnetic compositions, such as the photocatalyst coated magnetic substrate particles shown in FIG. 1(a). The typical size of the coated composite particles is on the order of micrometers to a few millimeters.

Inflow to the fluidized bed carries the pollutants and mixes the photocatalytic particles with reagents in the fluidized bed, such as pollutants, enhancing mass transfer. The turbulence in the bed also promotes the exposure of the photocatalytic particles to the UV light source that is critical to the generation of hydroxyl radicals. The above two factors are important, especially to space applications, as a faster reaction rate reduces the size of the treatment device required for a given application. The relatively large size of the magnetic substrate particles is also important because the photocatalyst composite particles can then be easily separated from water under microgravity conditions. In addition to its potential role in long duration manned space missions, this technology also has numerous terrestrial and commercial applications where limited space is available and resupply is difficult.

Applied to long term space missions, the invention can provide a safe and comfortable air and water environment for astronauts. In addition, the composites can be applied to microgravity environments that are not compatible with systems which rely on gravitational settling to operate. Similarly, the invention can be applied to commercial flights where disease outbreaks due to viruses or bacteria through the air circulation system can occur. Other exemplary applications also include automobiles, warships, cruise ships, submarines, and where water resources may be significantly limited.

For application to space missions, the size and efficiency of devices employing photocatalysts such as titania are critically important. One of the key objectives for space missions is to maximize the reaction kinetics in a microgravity environment. A fluidized bed is a highly efficient means of increasing mass transfer within a system. Since the material within the bed is mobile, a larger amount of surface area is available for reaction as compared to a packed bed system. In addition, a fluidized bed system allows for lower pressure differentials across the bed, especially when particles are present in the waste stream to be treated. A fluidized bed system containing a photocatalyst provides an optimal arrangement for the generation of large quantities of hydroxyl radicals for use in removing pollutants.

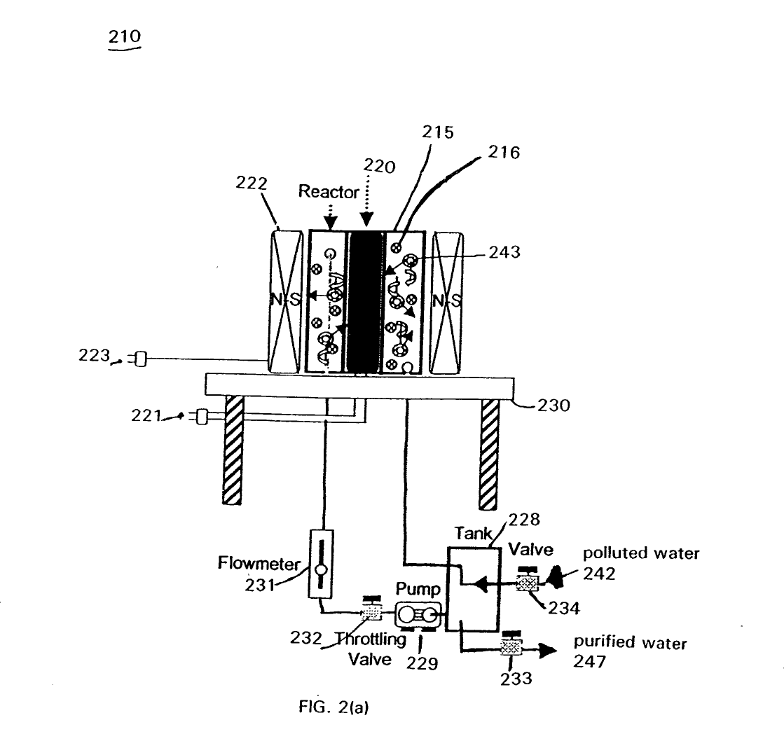

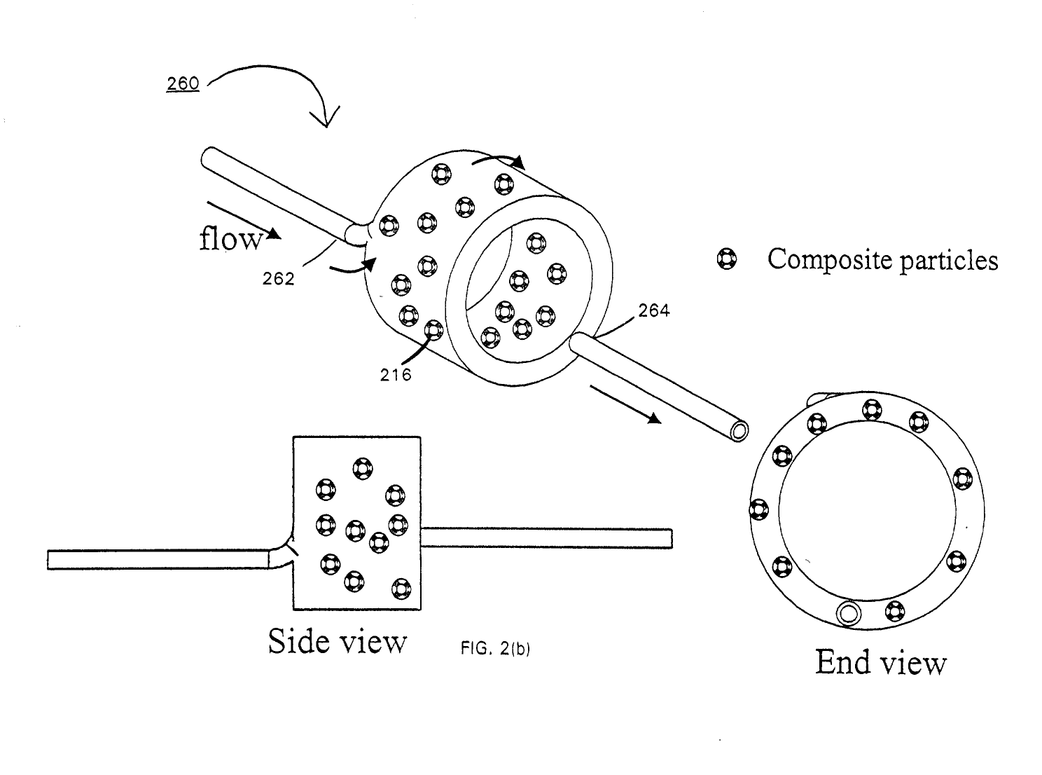

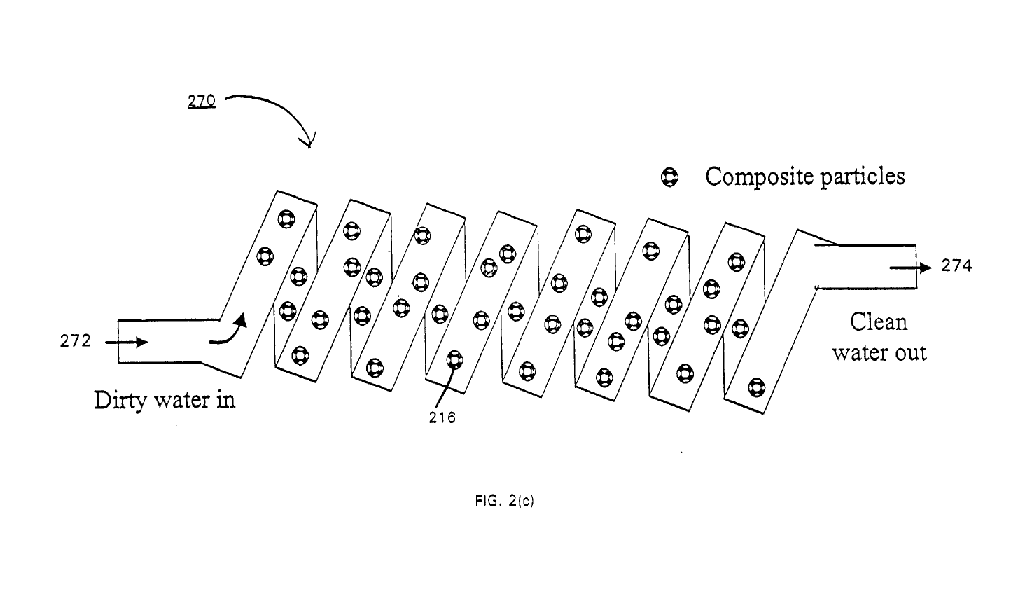

Photocatalytic reactor based systems can be constructed which use magnetic composite particles according to the invention which include nano-sized photocatalyst particles. For example, FIG. 2(a) illustrates a schematic view of a magnetically agitated photocatalyst reactor based system 210 for the treatment of water, according to an embodiment of the invention. Although described as a water recovery system, the system shown in FIG. 2(a) can be adapted for use generally as a liquid recovery/revitalization system.

System 210 includes reactor 215 which holds contaminated water and a plurality of photocatalyst-magnetic composite particles 216. UV lamp 220 and associate lamp power supply 221 provides photons for photocatalyst magnetic composite particles 216. The light intensity can be varied according to the application need.

Magnet 222, such as a collar coil, powered by power supply 223 provides a magnetic field within reactor 215 to control the movement of magnetic photocatalyst magnetic composite particles 216. The UV lamp 220, reactor 215 and magnet 222 can be disposed on a suitable support, such as table 230.

An external magnetic field can be provided by passing current through a magnet, such as a collar coil using a variable low amperage power supply 223. If a collar coil is used, the collar coil preferably wraps around the entire reactor 215.

Power supply 223 controls the current passing through the coil, the current controlling the magnetic field. A time varying magnetic field preferably is used to control the agitation of the magnetic substrate particles 216. The magnetic field can also be designed to adapt to different magnitudes of gravity by varying the configuration of the coil. Under a controlled magnetic field, agitated particles can be forced to spin, rotate and otherwise move, thus efficiently mixing the photocatalyst composite particles and the pollutants. A field strength from 0.5 to 2 mT is generally sufficient to vigorously agitate the particles.

A typical coil current is 10-30 Amps rms. However, assuming an appropriate controller and power supply 223 is provided, the coil current and resulting magnetic field can be increased or decreased to values outside this current range.

System 210 also preferably includes tank 228 which acts as a reservoir so that the reactor 215 need not be on all the time if the flow rate to be treated is low, as well as pump 229, flow meter 231 and throttling valve 232. In operation of system 210, fluids, such as polluted water 242, including one or more pollutants, such as chemical and biological pollutants 243, enter reactor 215 through valve 234 which controls the flow rate to be treated.

Inflow of polluted water 242 to reactor 215 carries the pollutants 243 therein and mixes the photocatalyst magnetic composite particles 216 with pollutants 243. Reactor 215 can be operated in a continuous, re-circulation mode or batch mode (e.g. slurry), depending on the flow rate requiring treatment.

A magnetic field from magnet 222 produces enhanced turbulence in reactor 215 as compared to an otherwise comparable system which operates without the aid of magnetic agitation. This promotes the exposure of the photocatalytic magnetic particles 216 to the UV lamp 220. Although a high flow rate to be treated can be used to enhance turbulent mixing, fluidization can be achieved even with a very low flow rate.

The photocatalyst magnetic composite particles 216 are exposed to the UV lamp near the center of the reactor to receive the irradiation necessary to cause the photocatalyst to generate hydroxyl radicals. If water or another fluid capable of providing hydroxyl radicals are not present in the fluid provided, a suitable concentration of the same should be added. Hydroxyl radicals generated react with most pollutants 243.

Following an appropriate reaction time, pump 229 can remove the treated water from reactor 215. Purified water 247 is thus produced by system 210.

Reactor 215 can be embodied in various forms. The reactor chamber design preferably prolongs the residence time of the water or other liquid in the system. For example, FIG. 2(b) includes an annular view, a side view and an end view of an annular reactor 260, according to an embodiment of the invention. In reactor 260, fluid (e.g. water) enters reactor 260 at input 262 flows annularly between concentric cylindrical walls before leaving reactor 260 at output 264. Reactor 260 can be used horizontally or vertically. Photocatalyst coated magnetic particles 216 are dynamically distributed in reactor 260 by magnetic agitation.

Another embodiment of reactor 215 is shown in FIG. 2(c). FIG. 2(c) illustrates a schematic view of a coil reactor. A spiral coil chamber can provide a smaller void space and a correspondingly larger effective volume as compared to other reactor configurations. In operation, a fluid, such as water enters reactor 270 at input 272, follows the coil path and exits reactor 270 at output 274. Reactor 270 can be used horizontally or vertically. As in the other embodiments, photocatalyst magnetic composite particles 216 are dynamically distributed in reactor 270 by magnetic agitation.

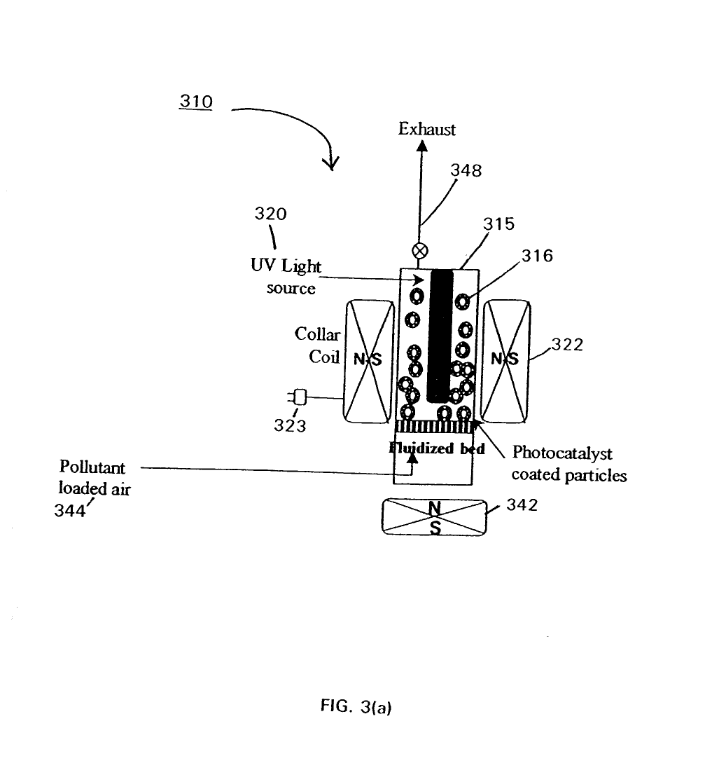

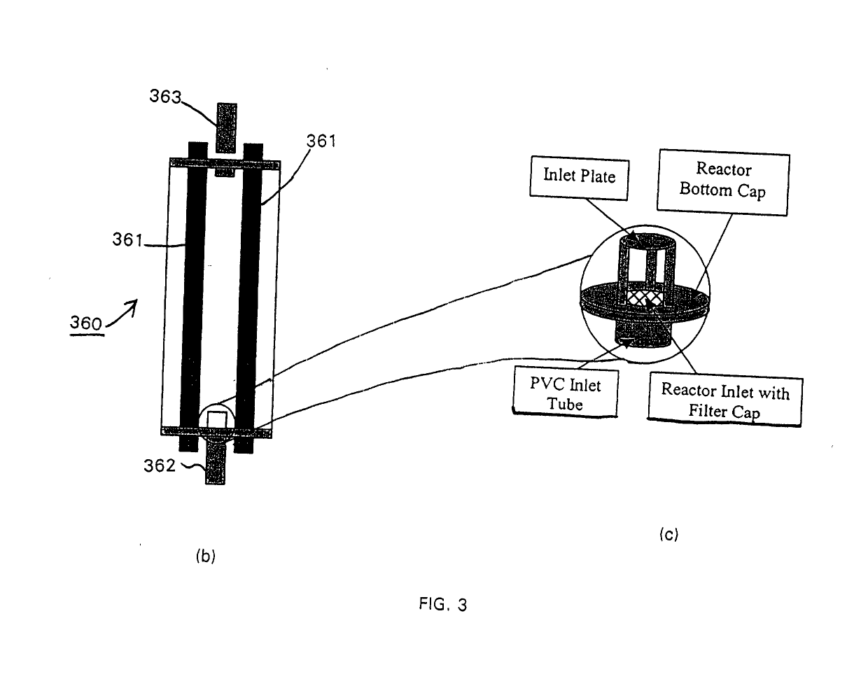

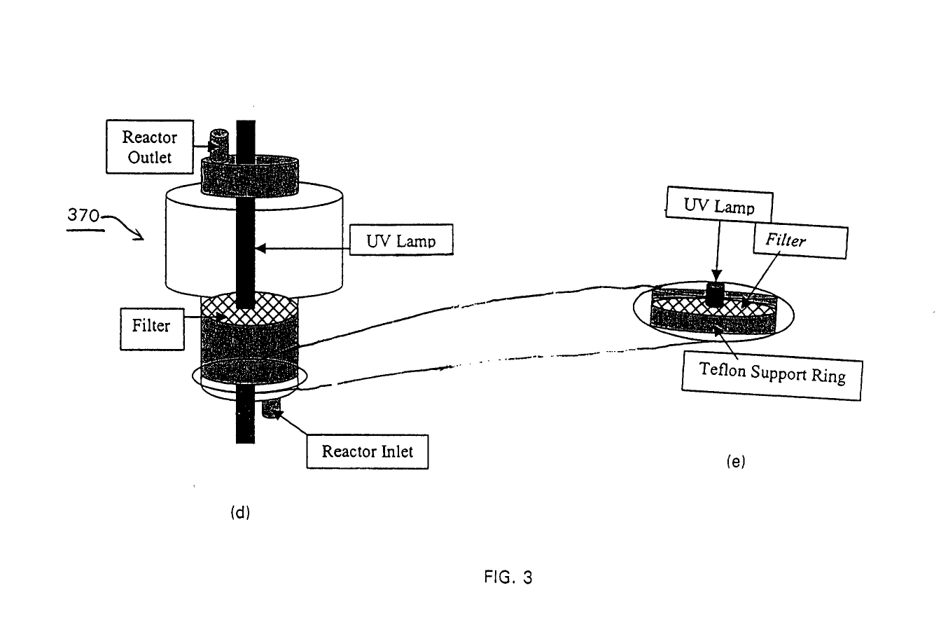

A reactor based system for air revitalization is shown in FIG. 3(a). This system and reactors used are similar to those shown in FIGS. 2(a)-(c). However, instead of introducing a liquid such as water, a gas, such as air is introduced from the reactor bottom to fluidize the magnetic photocatalyst composite particles. Although described as an air recovery system, the systems shown FIGS. 3(a)-(c) can be adapted for use generally as a gas recovery system.

For example, FIG. 3(a) illustrates a schematic view of a magnetically agitated photocatalyst reactor based system 310 for the treatment of air, according to yet another embodiment of the invention. System 310 includes reactor 315 which includes a plurality of unbound photocatalyst magnetic composite particles 316. UV lamp 320 provides photons for photocatalyst magnetic composite particles 316. Magnet 322, such as a collar coil, powered by power supply 323 provides a magnetic field to control the movement of photocatalyst magnetic composite particles 316. Secondary magnet 342 shown is used for applications in micro-gravity environments, such as space.

Besides due to air flow, the composite particles 316 are also be agitated by the external magnetic field created by passing alternating current through magnet 322, such as a collar coil. The agitation further enhances the fluidization and is almost entirely responsible for fluidization when the flow velocity is not high enough to mechanically fluidize the particles.

In operation of system 310, pollutant loaded air influent 344, including pollutants such as chemical and biological pollutants, enters reactor 315 through a suitable valve (not shown). Through an optional screen (not shown), the air flow can be more uniformly distributed for fluidization.

Pollutant loaded air 344 mixes with photocatalyst magnetic composite particles 316. Magnetic field from magnet 322 produces enhanced turbulence in reactor 315 which promotes the exposure of the photocatalyst magnetic particles 316 to the UV lamp 320 and also increases the generation rate of hydroxyl radicals which react with pollutants provided by pollutant loaded air 344. Exhaust 348 from reactor 315 is purified air.

Reactor 315 can be embodied in various forms. For example FIG. 3(b) illustrates a schematic view of a central flow reactor 360 according to an embodiment of the invention. The schematic shown displays two black lamp tubes 361 running through the reactor 360 and inlet 362 and outlet ports 363 at the top and bottom of the reactor. FIG. 3(c) illustrates an enlarged view of the inlet entrance of reactor 360. The enlarged schematic shows an isometric view of the inlet entrance with the plate located just above the inlet to reactor 360.

FIG. 3(d) illustrates a schematic view of a central lamp reactor 370 including an enlarged view of the inlet entrance, according to an embodiment of the invention. FIG. 3(e) illustrates an enlarged schematic of reactor 370 showing a view of the inside of the ring supporting the inlet filter and the UV lamp running through the filter.

Nano-sized TiO₂ particles can be directly coated on the surface of magnetic substrate particles having sizes in the micrometer to millimeter range (i.e. a shell of TiO₂ particles on the substrate particles). Although a single layer of titania particles is shown schematically in FIG. 1(a) on a magnetic substrate, the invention is not limited to a single photocatalyst particle layer. The composite particles produced by such methods are large enough for fluidization while the superior photocatalytic capability of the nano-sized photocatalyst is preserved.

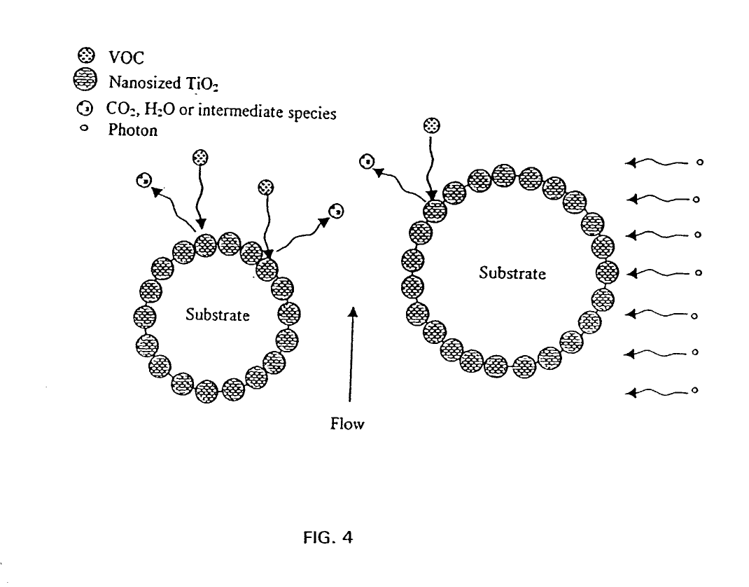

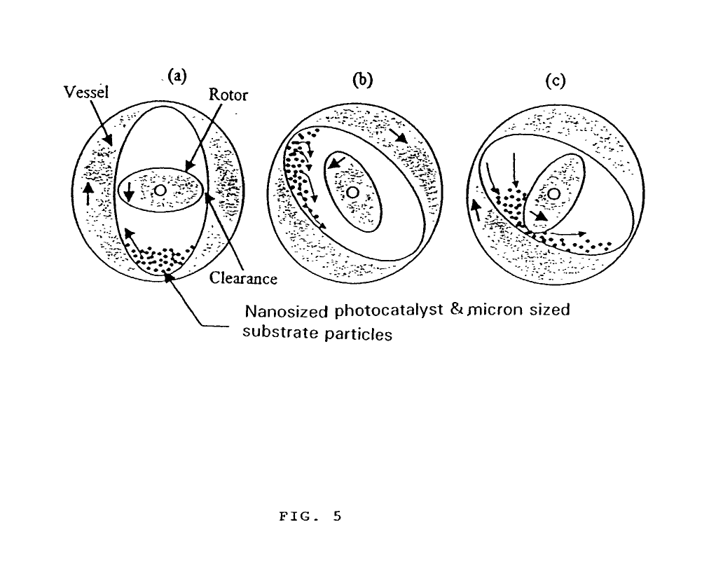

FIG. 4 depicts the composite's mechanism for removing volatile organic compounds (VOCs). Incident photons of light strike the titania particles generating reactive OH radicals nearby. VOCs react with the OH radicals that are positioned nearby the titania particles, thereby resulting in formation of CO₂, H₂O or intermediate species.

FIG. 5 shows steps involved in the formation of nano-sized photocatalyst particles using a dry coating process. In one embodiment, coatings are applied using a dry coating machine, such as a Theta Composer. Nano-sized photocatalysts and substrate particles are placed in the space between the vessel and rotor (FIG. 5(a)). The outer vessel rotates slowly to blend the particles while the inside rotor rotates very quickly (FIG. 5(b). When the rotor and the vessel are in the configuration as shown in FIG. 5(c), particles are forced to pass through the narrow clearance, and are subjected to high stress, resulting in formation of the coating. Coating conditions can be controlled by the appropriate selection of parameters including the clearance and the rotation speed.

### EXAMPLES

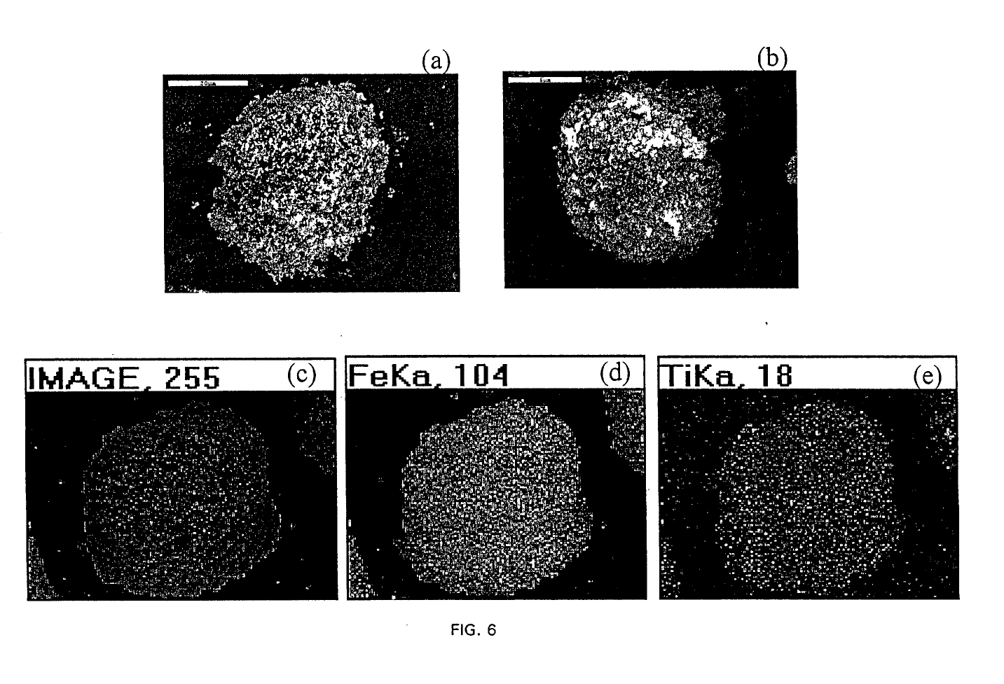

Several coated particles have been formed. FIG. 6 shows SEM and EDX images of nano-sized TiO₂ particles coated on Fe₃O₄. Favorable results were achieved. As shown in FIG. 6(e), nano-sized TiO₂ particles are distributed uniformly on the surface of the Fe₃O₄ substrate. Note that the original TiO₂ is agglomerated (FIG. 6(b)). However, the high shear force of the process has degglomerated and dispersed the TiO₂ particles. Thus, a nearly uniform photocatalyst coating was achieved.

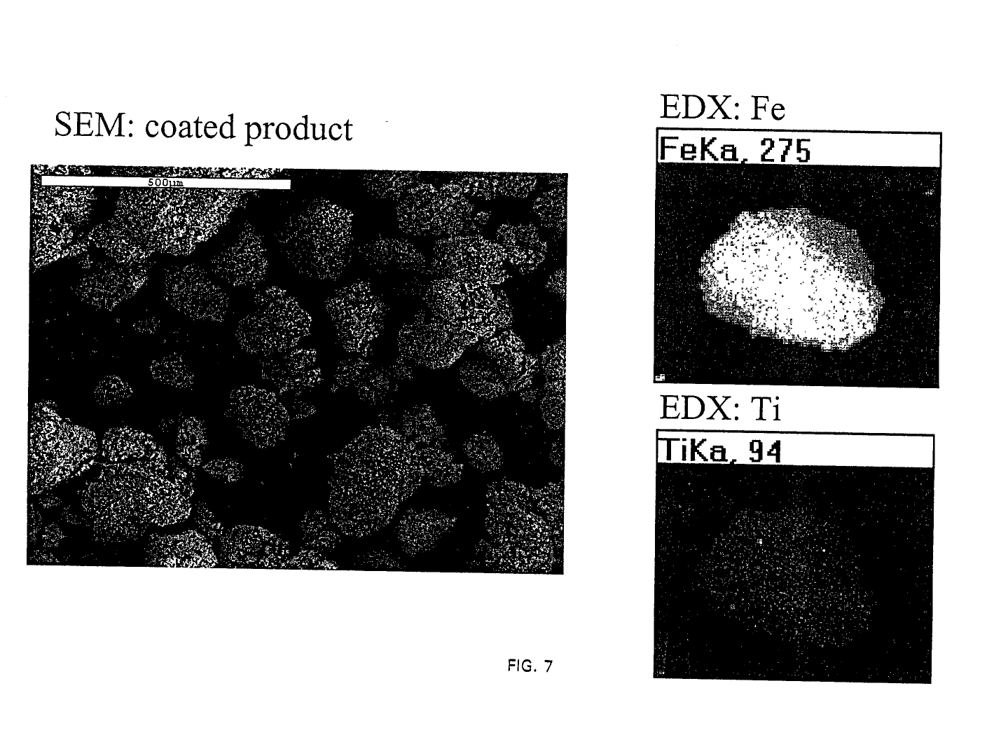

FIG. 7 shows SEM and EDX images of nano-sized TiO₂ particles coated on polymethylmethacrylate (PMMA), the PMMA coating Fe₃O₄. A distribution of particle sizes is shown. The images provide evidence of the existence of Ti coating on the surface.

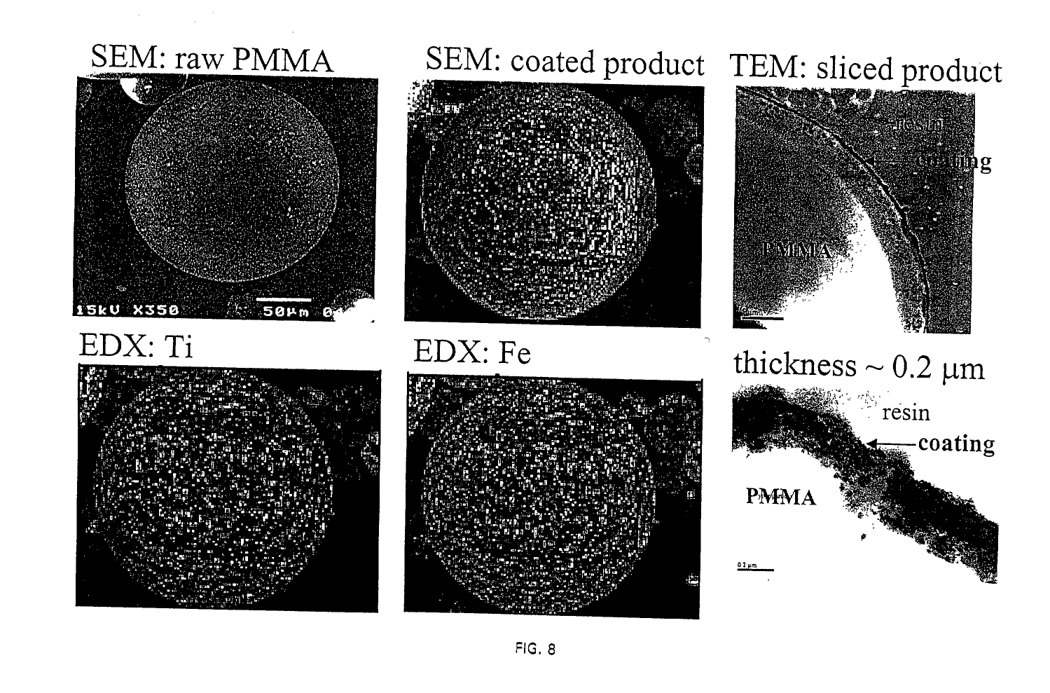

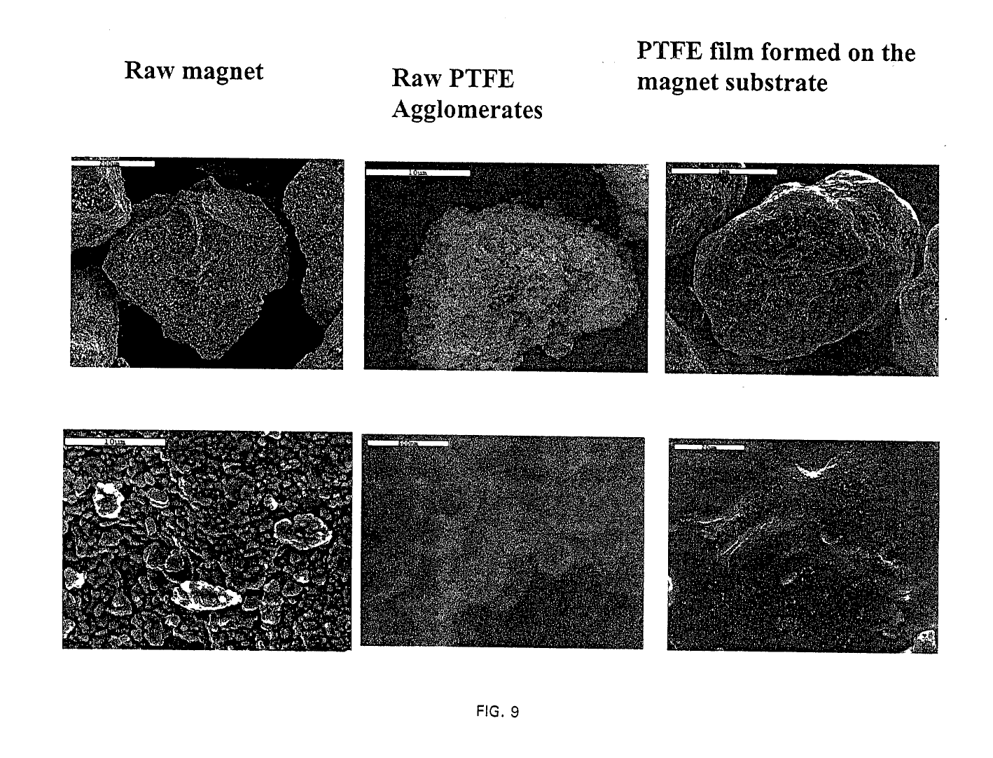

FIG. 8 shows SEM, EDX and TEM images of PMMA particles coated with nano-sized TiO₂ and Fe₃O₄. The EDX images show that Ti and Fe are uniformly distributed on the surface. The TEM images of the sliced product show that the coating layer is a thin layer.

FIG. 9 shows SEM images of a magnetic substrate, PTFE, and a PTFE coated magnetic substrate. The lower images represent magnified versions of their respective upper images. The PTFE layer is designed to protect the magnet substrate from harsh environmental conditions.

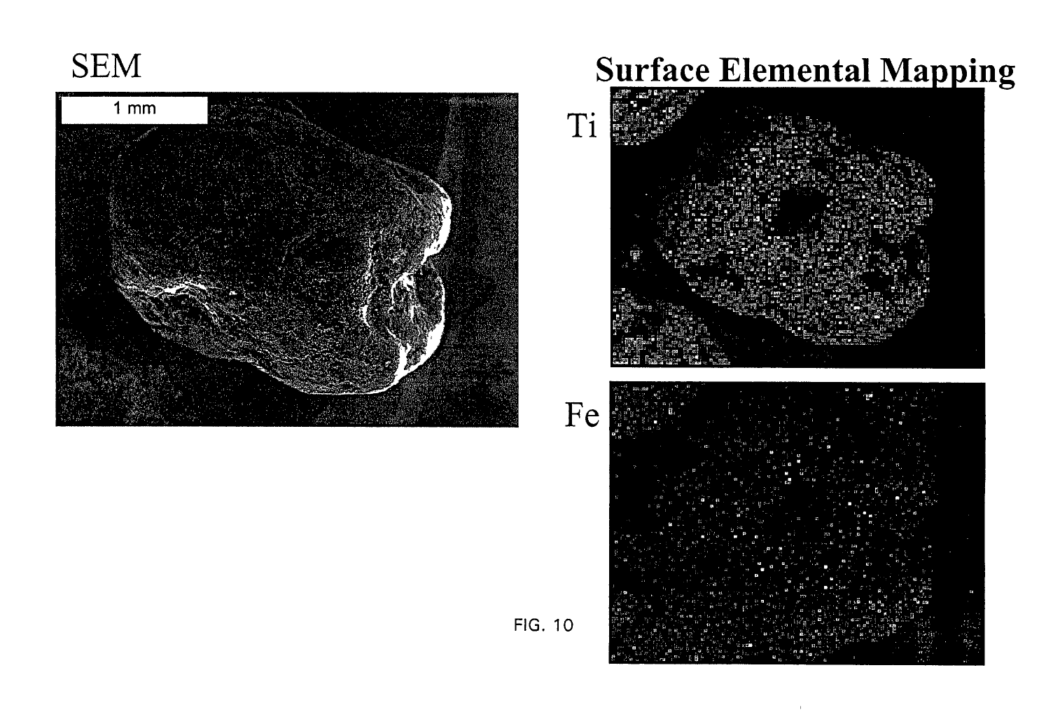

FIG. 10 shows SEM and surface elemental mapping by EDX of BaO(Fe₂O₃)₆ coated with a layer of PTFE and then nanosized TiO₂ particles. The Fe signals shown appear rather dim due to the layer of TiO₂ on top of the magnet. The dim Fe signal provides additional evidence that TiO₂ is coated on the surface of the BaO(Fe₂O₃)₆ magnet.

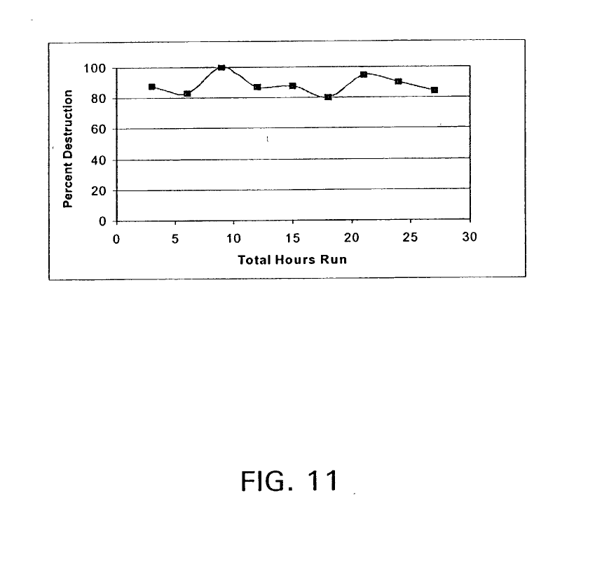

An exemplary system was configured and tested to assess system treatment performance. FIG. 11 is a collection of batch data showing destruction of methylene blue dye as a function of time in a coil reactor using magnetic photocatalytic composite particles. The fluid flow treated included 2 mg/L of methylene blue dye. The reactor was provided with a plurality of magnetic photocatalytic composite particles comprising 625 mg of BaO(Fe₂O₃)₆ magnetic core particles coated with a 1 wt. % PTFE protection layer and 6 wt. % TiO₂.

Each data point shown in FIG. 11 represents either a 3 or 4 hour run. After each run, the dye solution was replenished with fresh solution and a new experiment using the same particles was restarted. The average destruction efficiency for each run shown was about 90%. Durability of the coating is also evident as the magnetic photocatalytic composite particles were still active after 27 hours of treatment.

While the preferred embodiments of the invention have been illustrated and described, it will be clear that the invention is not so limited. Numerous modifications, changes, variations, substitutions and equivalents will occur to those skilled in the art without departing from the spirit and scope of the present invention.

We claim:

1. A magnetic photocatalyst composite particle, comprising:
a magnetic composition, and
at least one photocatalyst particle secured to said magnetic composition.

2. The magnetic photocatalyst composite particle of claim 1, wherein said photocatalyst particles are nano-sized.

3. The magnetic photocatalyst composite particle of claim 2, wherein said nano-sized photocatalyst particles are substantially uniformly distributed on a surface of said magnetic composition.

4. The magnetic photocatalyst composite particle of claim 2, further comprising a protective layer disposed on said magnetic composition for preventing chemical attack of said magnetic composition.

5. The magnetic photocatalyst composite particle of claim 2, wherein said nano-sized photocatalytic particles are selected from the group consisting of TiO₂, ZnO and Fe₂O₃.

6. The magnetic photocatalyst composite particle of claim 1, wherein said magnetic composition is at least one selected from the group consisting of Fe₃O₄, Fe₂O₃, BaO(Fe₂O₃)₆, SrO(Fe₂O₃)₆ and AlNiCo.

7. A magnetic photocatalyst composite particle, comprising:
a substrate core, and
at least one nano-sized photocatalyst particle and at least one nano-sized magnetic particle, said nano-sized particles disposed on said substrate core.

8. The magnetic photocatalyst composite particle of claim 7, wherein said nano-sized photocatalytic particles are formed from at least one selected from the group consisting of TiO₂, ZnO and Fe₂O₃.

9. The magnetic photocatalyst composite particle of claim 7, wherein said substrate core is at least one selected from the group consisting of Fe₃O₄, Fe₂O₃, BaO(Fe₂O₃)₆, SrO(Fe₂O₃)₆ and AlNiCo.

10. A chemical reactor, comprising:
a photocatalytic fluidized bed comprising a plurality of magnetic photocatalyst composite particles, said magnetic photocatalyst composite particles comprising a magnetic composition and at least one photocatalyst particle secured to said magnetic composition; and
structure for creating turbulence for mixing.

11. The reactor of claim 10, wherein said photocatalyst particles are nano-sized.

12. The reactor of claim 11, wherein said magnetic photocatalytic composite particles are at least one selected from the group consisting of a first particle type having a magnetic composition and at least one nano-sized photocatalyst particle secured to said magnetic composition, and a second particle type having a substrate core and at least one nano-sized photocatalyst particle and at least one nano-sized magnetic particle secured to said substrate core.

13. A photocatalyst fluidized bed, comprising:
a plurality of magnetic photocatalyst composite particles, said magnetic photocatalyst composite particles comprising a magnetic composition and at least one photocatalyst particle secured to said magnetic composition; and
structure for creating turbulence for mixing.

14. The photocatalyst fluidized bed of claim 13, wherein said photocatalyst particles are nano-sized.

15. The photocatalyst fluidized bed of claim 14, wherein said structure for creating turbulence includes at least one magnetic field source.

16. A method for performing photocatalysis, comprising the steps of:
providing magnetic photocatalyst composite particles in a fluidized bed;
supplying light and a material to be purified intermixed with reactant particles to said fluidized bed; and
applying a magnetic field to influence movement of said photocatalyst composite particles to increase mixing between said photocatalyst composite particles and said reactant particles.

17. The method of claim 16, wherein said magnetic photocatalyst composite particles include nano-sized photocatalyst particles.

18. The method for performing photocatalysis of claim 17, further comprising the step of varying at least one selected from the group consisting of magnetic field strength and magnetic field direction.

19. The method for performing photocatalysis of claim 16, further comprising the step of varying the intensity of said light.

20. The method for performing photocatalysis of claim 16, wherein said material to be purified is water.

21. The method for performing photocatalysis of claim 16, wherein said material to be purified is air.

22. A method for controlling pollution, comprising the steps of:
providing a plurality of magnetic photocatalyst composite particles, said magnetic photocatalyst composite particles being at least one selected from the group consisting of a first particle type having a magnetic composition, and at least one nano-sized photocatalyst particle secured to said magnetic composition, and a second particle type having a substrate core and at least one nano-sized photocatalyst particle and at least one nano-sized magnetic particle secured to said substrate core, and
applying a magnetic field to influence movement of said particles.

23. A process for forming magnetic photocatalyst composite particles, comprising the steps of:
providing a plurality of magnetic substrate particles, a plurality of nano-sized photocatalyst particles and a coating machine, said coating machine having a rotor and a vessel and a volume therebetween, said volume including a region with a narrow rotor clearance relative to other volumes between said vessel and said rotor;
positioning said plurality of magnetic substrate particles and nano-sized photocatalyst particles in a volume between a vessel and a rotor, and
rotating said rotor, wherein said nano-sized photocatalyst particles coat said magnetic substrate particles.

24. A process for forming magnetic photocatalyst composite particles, comprising the steps of:
providing a plurality of magnetic substrate particles, a plurality of photocatalyst particles and at least one oxidizing acid,
dissolving said photocatalyst particles in said acid to form a solution, and
removing said acid, wherein a plurality of photocatalyst particles are deposited on the surface of said magnetic substrate particles.

25. The method of claim 24, wherein said deposited photocatalyst particles are nano-sized.
